(19) United States
(12) Patent Application Publication
(10) Pub. No.: US 2015/0006655 A1
(43) Pub. Date: Jan. 1, 2015

(54) Intra-conversation Text Message Threading

(71) Applicant: Daniel Fradin, Fairless Hills, PA (US)

(72) Inventor: Daniel Fradin, Fairless Hills, PA (US)

(21) Appl. No.: 14/320,523

(22) Filed: Jun. 30, 2014

Related U.S. Application Data
(60) Provisional application No. 61/840,549, filed on Jun. 28, 2013.

(51) Int. Cl. H04L 12/58

(52) U.S. Cl. CPC H04L 51/16
USPC 709/206

(57) ABSTRACT

A method and system for the deliberate arrangement of text messages on a conventional digital device is presented. A software application interfaces with the native text messaging application on the digital device, and provides a means for the user to link individual response text messages to individual question text messages within a conversation. The system is designed to prevent miscommunication between two users during conventional message exchanges by correlating or pairing messages such that the correlation continues as responses are sent to a second digital device.

This application is a non-provisional application of provisional application No. 61/840,549 filed on Jun. 28, 2013, and priority is claimed thereto.

### FIELD OF THE PRESENT INVENTION

The present invention relates to the deliberate ordering and organization of text-based communications or messages, and more specifically, text messages such as SMS or MMS messages or other instant messages conveyed to electronic devices via a network.

### BACKGROUND OF THE PRESENT INVENTION

As cellular networks become more widespread, and cellular phone technologies continue to advance, individuals have come to rely on their phones more each year. People conventionally employ their cellular or mobile phones for phone calls, text messages, running applications, and browsing the internet. Studies show that modern smart phones are used most for text messages, secondly for running applications and internet browsing, and lastly for phone calls.

While extended use of a cell phone's text messaging feature has gotten easier for users via new keyboard designs, larger screen real estate, and faster message delivery, little progress has been made on the client software or phone side of the text message sending and receiving process. Conventionally, messages are displayed in accordance with the order they are received and sent, and are threaded together in this order, simulating a back-and-forth conversation between two individuals. However, fast-paced conversations can quickly become confusing or convoluted. For example, during instances and conversations that present multiple questions simultaneously, or in concurrent messages, the receiving device may present the prompting questions in a manner that would confuse the responder as to which message corresponds to which question, and vice versa.

Similarly, network latency occasionally affects text messages that are transmitted too quickly in succession, especially in longer texts that are too big for the 160 character limit of conventional texting protocols, and must automatically be split into two or more parts for transmission. Often, these messages are delivered in an order that is not consistent with the order in which they were sent, causing the receiver confusion. In these cases, the receiving individual must reconstruct the correct sequencing of messages based on the contents and context of each portion of the message. Occasionally, this process is performed incorrectly on accident, causing a miscommunication.

Thus, there is a need for a means of managing incoming and outgoing messages on digital devices such that the individual is empowered to deliberately group messages according to the topic at hand, including but not limited to those statements related to specific posed questions and answers. Additionally, there is a need for this imposed grouping of messages to be conveyed and shared between sender (person A) and receiver (person B), such that the specific statements relevant to a conversation topic remain grouped and associated on both mobile devices facilitating the conversation.

U.S. Pat. No. 7,831,267, by Klassen et al., patented on Nov. 9, 2012 is for a Text Messaging Conversation User Interface Functionality. Klassen employs a similar goal to the present invention, however the present invention is designed to accommodate only a single one-on-one conversation over conventional wireless devices configured with conventional text messaging capabilities.

U.S. Pat. No. 8,166,408 B2 by Castellucci, and Patented on Apr. 24, 2012 is for ‘Management of Virtual Discussion Threads in a Conferencing System’ is similar to the present invention in that it is designed to group text messages, however Castellucci is designed to group messages in multiple (more than two) contact conversations on the same screen. The present invention is configured to preferably be employed to categorize messages based on conversation topic between only two people.

U.S. Publication No. US 2012/0331405 A1 by Eidelson et al, and published on Dec. 27, 2012 is for a “Group Conversion Between A Plurality of Participants.” Eidelson et al., teaches a means of grouping text massages in a conversation between more than two individuals. Unlike the present invention, Eidelson et al. is designed to facilitate the process of text message use among a group of individuals numbering greater than two, whereas the present invention is crafted to eliminate confusion during a text-based conversation between two individuals.

U.S. Publication No. US 2013/0007037 A1, published by Azzam et al. on Jan. 3, 2013 is for ‘Automatic Question and Answer Detection.’ Azzam et al. is similar to the present invention in that it groups questions and answers to questions within a text messaging conversation into threads according to the context of the conversation. Azzam et al. teaches a system for automatically detecting and grouping sets of questions that correlate to sets of answers. For Azzram et al, grouping is performed automatically via software computations. However, the present invention groups question and answer pairs in a text message conversation according to deliberately selected messages selected by the sender and/or the receiver.

U.S. Pat. No. 7,831,267, by Klassen et al., patented on Nov. 9, 2012 is for a Text Messaging Conversation User Interface Functionality. Klassen employs a similar goal to the present invention; however, the present invention is used for conversations between only two individuals, and is designed to function in association with the native text messaging application of the mobile device, employing the native user interface when possible.

### SUMMARY OF THE PRESENT INVENTION

The present invention is a method and system for the deliberate reordering of text messages on a digital display of a mobile phone, smart phone, or other preferably wireless digital device. Rather than displaying messages (ideally, SMS/MMS text messages) according to the time at which they were received (despite network lag or interference), as is the default order on conventional digital devices, the present invention is designed to display text messages on the display of mobile devices as grouped and threaded by the conversation to which each message is written in response to a prior message.

For example, within a common text-based conversation, multiple threads of inquiry may arise, especially during those conversations including at least two questions posed or asked in sequential incoming messages. If the response to the first question is not sent prior to the second question arriving, the sender of the questions may confuse the answers. As a result of this, confusion may arise when responses are received as to which text message question is matched to which text message answer or response. Conversations can quickly grow to be long with multiple instances of questions or similar statements, which can lead to miscommunication, misunderstanding, or even loss of meaning Add this to the fact that many text messages have poor grammar and misspellings, and it is even easier to see how meaning can be misconstrued.

The present invention solves this problem via a software application programmed to group messages for the user according to manually established grouping input via the sender of the responses. The mechanism for grouping texts by conversation to avoid miscommunication comprises a 4-step procedure primarily consisting of the following:

a) A user taps the individual text message within the text messaging application of the first digital device, indicating the message that the user would like to reply to.

b) That text message comes into view by dropping to the bottom of all threads listed on the display screen of the digital device. A red arrow appears on or near the selected text message, indicating that the reply will now be associated with that text message.

c) With the application of the present invention enabled, the grouping created on the first digital device will appear on both the recipient's second digital device and the sender's first digital device.

d) Tapping on a toggle switch to disable the application will ungroup the texts. Texts will then appear in original chronological order. This action may be performed on the first digital device, the second digital device, or both.

The software of the present invention is crafted to function on most mobile devices having a digital display screen, a wireless radio/receiver, and connection to a network. The present invention preferably runs concurrently and in association with the native texting application on the mobile device. Alternate embodiments of the present invention may be incorporated directly into the native text message application, often supplied by the manufacturer of the digital device. Conversely, other embodiments of the present invention may include an application designed to handle all text messaging features and functionality, such as within those self-contained, third-party text messaging applications known to be available in conventionally app stores.

The present invention primarily consists of the application that is preferably running on the mobile devices employed by both the message sending and message receiving party. The application of the present invention preferably employs conventional coding techniques to interface with the native text messaging application installed on the digital device.

### BRIEF DESCRIPTION OF THE DRAWINGS

FIG. 1 shows an example screenshot of the preferred embodiment of the present invention, detailing the grouping indicator.

FIG. 2 shows a conventional text messaging application equipped with the present invention while the present invention is turned off.

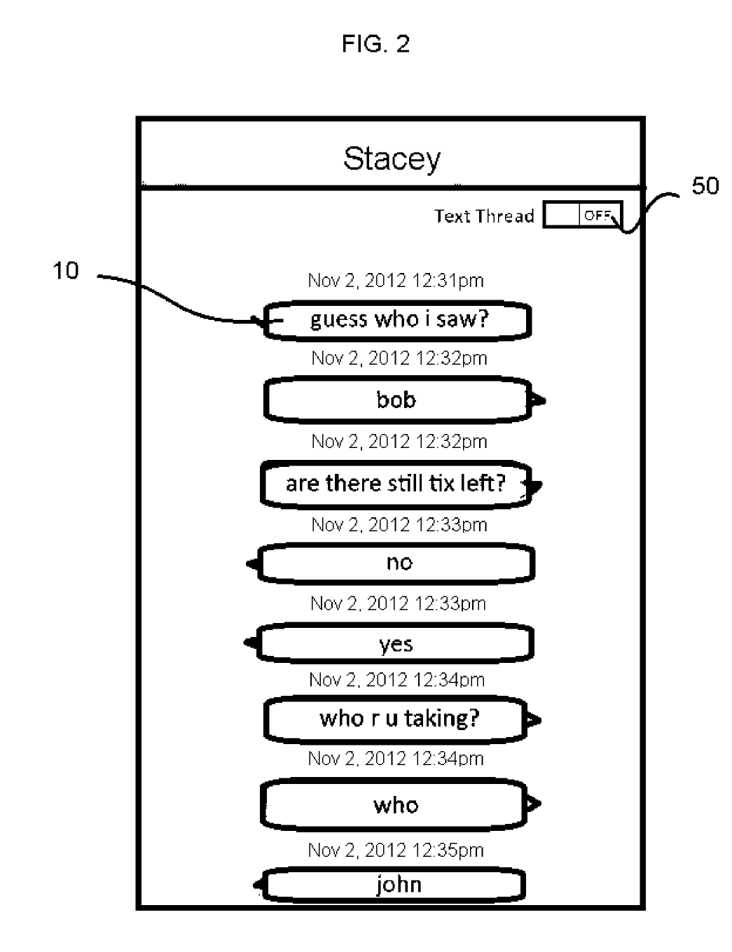

FIG. 3 exhibits a flow chart detailing the steps of the present invention.

### DETAILED DESCRIPTION OF THE PREFERRED EMBODIMENT

The present invention is a method and system designed to facilitate the deliberate grouping of text messages (10) based on the context of the conversation at hand according to predefined associations created by a user of an application interfaced with the native mobile device text (SMS/MMS) application. The preferred embodiment of the present invention employs a set of basic steps designed to simply text messaging conversations that take place between two individuals. The basic steps of the present invention are outlined as follows:

a) First, a user taps the individual text message within the text messaging application of the first digital device, indicating the specific text message that the user would like to reply to (100)

b) The selected text message comes into view by dropping to the bottom of all threads listed on the display screen of the digital device (110). A red arrow, referred to as a grouping indicator (60) appears on or near the selected text message, indicating that selected text message is ready to be replied to, or grouped with, a prior message (120). The user may then craft a reply and click ‘send’ (125).

c) With the application of the present invention enabled, the grouping created on the first digital device will appear on both the recipient's second digital device and the sender's first digital device after the text message is sent and received (130).

d) Tapping on a grouping switch to disable the application will ungroup the texts (135). Texts will then appear in original chronological order (140). This action may be performed on the first digital device, the second digital device, or both.

The present invention allows a first user using a first digital device (20) to group texts by conversation and avoid miscommunication. When the receiving second digital device (30) is running the application of the present invention, the application also ensures text messages are similarly grouped on the second user's digital device. It should be understood that the present invention requires two digital devices, a first digital device (20) and a second digital device (30), in order to facilitate a successful grouped text message conversation. A digital device preferably includes any digital device capable of sending and receiving text messages, and displaying them on a digital display (40). Both the first digital device (20) and the second digital device (30) are preferably equipped with a wireless network radio/receiver (GPS/GPRS/LTE/CDMA/HSPA) connected to a cellular network, and at least one mode of user input such as a keyboard or voice recognition.

The present invention provides for a user to group the text messages that have already occurred within the thread, making review of the conversation much easier. In order to accomplish the grouping of older or non-instant text messages, the user preferably performs a series of steps nearly identical to the steps required for grouping active conversation messages. For example:

a) First, a user taps the individual text message within the text messaging application of the first digital device, indicating the message that the user would like to reply to. (100)

b) The selected text message comes into view by dropping to the bottom of all threads listed on the display screen of the digital device. (110) A red arrow, referred to as a grouping indicator (60) appears on or near the selected text message indicating that selected text message is ready to be replied to or grouped with a prior message (120).

c) The user then selects a second, older text message to be grouped with the selected text message referenced by the grouping indicator (60).

d) The application registers the grouping and displays the selected text message and the older text message in a grouped thread (160).

Unlike other instances of text message grouping indicated in the prior art, the present invention enables a user to group text messages to support context-sensitive messaging that correctly conveys meaning and conversation continuity without any application coded rule or algorithm in place to cause the automatic grouping of text messages. The application of the present invention preferably accomplishes this by transmitting message grouping metadata (170) which is created by the user when the grouping indicator (60) is active, over the network to the second digital device (30). The message grouping metadata (170) is preferably transmitted at the same time that the text message is transmitted to the receiving digital device, and preferably arrives at the second digital device (30) simultaneously with the text message. The second digital device (30), also concurrently running the application of the present invention with the native text messaging application of the device, interprets the message grouping metadata (170) and displays the text messages in the same position and order as displayed on the first digital device (20).

A grouping switch (50) is preferably included in the user interface (70) of the application of the present invention, and is designed to empower the user with the ability to group or ungroup the text messages in view on the digital display (40) with minimal effort. The grouping switch (50) may be tapped or swiped in order to enable or disable the present invention.

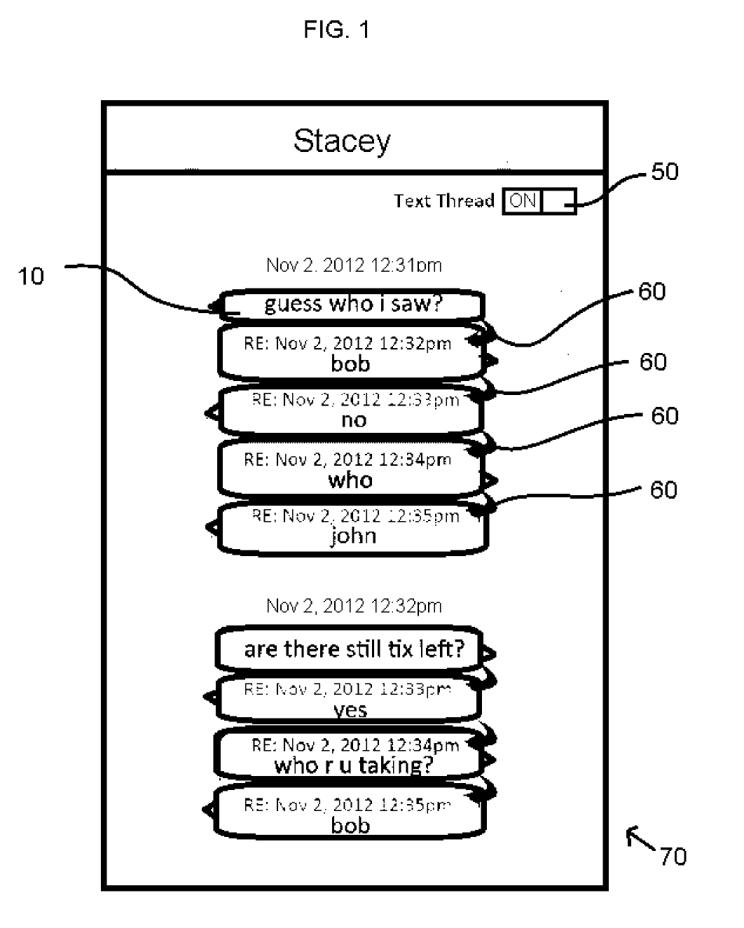

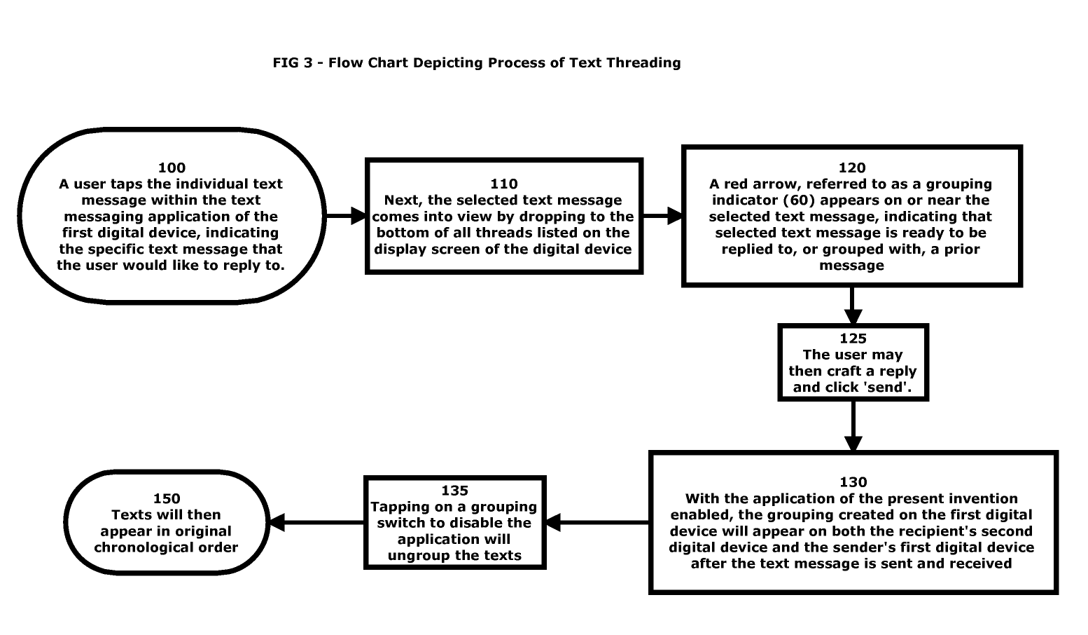

As previously mentioned, the present invention is preferably equipped with a grouping indicator (60), which is present on the digital display (40) when an individual text message is selected by a user with the intent of being grouped with a prior, older text message, or to be paired with a response text message in progress. As seen in FIG. 1 and FIG. 3, the grouping indicator (60) is envisioned to be a red arrow or similar red indicator, designed to expressly indicate the designated text message deliberately selected via user input.

The software application of the present invention has a small series of rules pertaining to its successful operation. Below is a basic outline of the rules employed by the present invention. It should be understood that these rules are guidelines that may be changed in accordance with new developments of the software of the present invention as it is refined. Additionally, the rule set below is envisioned to apply to a single embodiment of the present invention. Additional embodiments may employ slightly different rule sets.

1. The grouping of texts is preferably an all or nothing event on each user's device

2. Text grouping is automatically saved between states of the application of the present invention, whether it is on or off

3. Text grouping is limited to 25 individual texts per group, however it should be understood that some embodiments of the present invention may support unlimited text grouping.

4. Once a text is grouped, it cannot be removed from that group [possible future release]

5. Texts that are part of the thread in the application of the present invention off state have an visual mark indicating that it's part of a grouped text

6. There is no notification between Sender and Recipient whether the application of the present invention is On/Off or installed on each other's device.

7. If both users have the application of the present invention turned on, text grouping happens automatically between devices with most recent grouping reply at the bottom of the application of the present invention screen

8. If the Sender has the application of the present invention turned on, but the Recipient has the application of the present invention turned off, then the Recipient gets a visual indicator that stays with text saying that the application of the present invention must be turned on to see the grouping. The visual mark only goes away once the application of the present invention is turned on.

a. When the Recipient does turn the application of the present invention on, then the last grouped text or individual will be shown at the bottom of the UI.

9. There are two ways to create a threaded text conversation. The user can do this with the user's own texts or recipients.

a. Tapping on an existing text or group of texts which brings that text or group of texts into focus at the bottom of the UI and above the keyboard. User types in message and hits “Send” button.

b. Dragging an existing text to an individual text or group of texts. Groups cannot be threaded with other groups [possible future release]. Once user makes the association, there is a prompt asking to either “Send Thread” or “Cancel”.
i. “Send Thread”—sends data to Recipient's application of the present invention indicating that there is a new thread alert
ii. “Cancel”—undoes the thread and user is left at same place in UI where the text being dragged was originally located. Nothing is sent to the Recipient.

10. If Recipient has the application of the present invention turned off at the time that the Sender does a grouping on their device then Recipient gets prompt that a new grouping has happened and to turn on the application of the present invention to view. The new grouping is saved and not shown until the application of the present invention is turned on.

a. If Recipient has not turned the application of the present invention on and tries to reply to an unviewed group text or a text that was already associated with a group, they get a prompt warning that all threading will be lost. They can only send that text if they agree to forgo threading.

11. If Recipient has deleted the grouping being associated in a response, then a prompt/alert will appear saying that “In order to view full thread, please recover missing texts”. Recipient is given two buttons, “Recover Thread” or “Ignore Thread”.

a. “Recover Thread” will download the missing texts and reassemble based on Sender's data

b. “Ignore Thread” will cancel out of the alert and show the text individually. There will be an icon that will allow the Recipient to request the full thread still from the Sender's device.

12. Sender or Recipient can only delete individual texts or a group of texts at a time. They cannot delete individual texts of a group regardless if the application of the present invention is turned on or off. [revise can delete last one but cannot move last one to another group]

a. If Sender or Recipient deletes an individual text that's part of a threaded group using another text management program, then in the application of the present invention, there shows empty spots where the missing texts would normally be.

An error message of “Text does not exist” appears where the text content normally would be seen.

13. Should the Recipient not have the application of the present invention installed, all texts will be shown in the default texting program's chronological order view. The Sender will have grouping. Any texts from the Recipient will not be threaded on the Sender's device.

Additionally, other text rules may be employed which provide for the present invention to function as intended without extensive limitation. It should be assumed or understood that there will be version of the present invention that would include different rules pertaining to the controlling, grouping, number of messages per group, visual indicators of groups, different methods of starting or deleting a group, removing or attaching a text to a group, and controlling the view state for grouped and ungrouped texts. It is envisioned that these alternative basic rules would be applied and enforced via conventional programming practices.

Likewise, it should be understood that the present invention may be configured to function in tandem with other text-based communication client applications, including but not limited to conventional instant messaging applications (such as ICQ, AOL Instant Messenger, MSN Messenger, ect.), and email applications. Consequently, these text-based communication client applications need not be solely running on portable digital devices such as cell phones and tablets, but that the system of the present invention may function to group messages conveyed via a computer application as well, such as those executed on the Microsoft Windows operating system or OSX.

Having illustrated the present invention, it should be understood that various adjustments and versions might be implemented without venturing away from the essence of the present invention. Further, it should be understood that the present invention is not solely limited to the invention as described in the embodiments above, but further comprises any and all embodiments within the scope of this application.

We claim:

1. A method for grouping text messages on a mobile device according to conversation response comprising:
the mobile device receiving an incoming text message;
the mobile device routing the incoming text message through a text messaging client application;
the text messaging client application displaying the received text message;
the text messaging client application interpreting the received text message;
the text messaging client application providing a selection option for each received text message;
the text messaging client application sending an outgoing text message with a grouping indicator in direct response to the incoming text via the input selection of the incoming text by the user; user;
the text messaging client application receiving a response to the outgoing text message marked with the grouping indicator; and
the text messaging client application displaying the response to the outgoing text message inline with the outgoing text message the response to the outgoing text message is responding to.

2. The method of claim 1, wherein said the text messaging client application interpreting the received text message indicates which outgoing text message the incoming text message is in response to via the grouping indicator.

3. The method of claim 1, further comprising the mobile device disabling the grouping of text messages when the user deactivates a grouping switch.
